(19) United States
(12) Patent Application Publication
(10) Pub. No.: US 2016/0158641 A1
(43) Pub. Date: Jun. 9, 2016

(54) TARGETING SYSTEM AND METHOD FOR VIDEO GAMES

(71) Applicants: Phillip B. Summons, Littleton, CO (US); Elliot P. Summons, Littleton, CO (US)

(72) Inventors: Phillip B. Summons, Littleton, CO (US); Elliot P. Summons, Littleton, CO (US)

(21) Appl. No.: 15/012,065

(22) Filed: Feb. 1, 2016

Related U.S. Application Data
(63) Continuation-in-part of application No. 13/870,578, filed on Apr. 25, 2013, now Pat. No. 9,248,370.

(51) Int. Cl. A63F 13/219

(52) U.S. Cl. CPC A63F 13/219

(57) ABSTRACT

A targeting system and methods of use provide a player of a first person shooter video game with enhanced weapon targeting. Vertical and horizontal lines extend outwardly from a game reticule. In some embodiments, the vertical and horizontal lines or bands extend across the display screen or window within the display screen. The present technology can be applied to display screens mechanically or electronically. In some embodiments an electronic device is situated between the gaming console and the display screen. In other embodiments, a piece of clear, thin-film material is cut to approximate the dimensions of the screen, with the key graphical design elements of the present invention screen printed on the piece of plastic. Static electricity may hold the film in place. In other embodiments, the film may be held in place by pressure sensitive adhesive, brackets, or the like.

### CROSS-REFERENCE TO RELATED APPLICATIONS

This application is a continuation in part of U.S. patent application Ser. No. 13/870,578 filed Apr. 25, 2013, now allowed, which is incorporated herein by reference in its entirety for all purposes.

### BACKGROUND

“First person shooter” games are defined as a video game genre that centers the gameplay on gun and projectile weapon-based combat through a first-person perspective. An example of a “first person shooter” game can be seen in FIG. 1. A “first person shooter” presents an experience to the player that he/she is actually in the game environment. What a player can see on the television screen is what the player would theoretically be seeing if the player was actually in the game environment. Most games in this genre are based on combat. Since these games are presented in a first person perspective, and these games are based on combat, what a player would see on the television screen is the weapon 4 the player is wielding (creating the illusion that the player him/herself is holding the weapon 4), the environment that the player is theoretically in (giving the player the illusion that the player him/herself is actually in the environment), targets 2 and the reticule 6.

A reticule (also spelled reticle) is what allows the player to target enemies and objects in the game environment. A reticule is generally represented as a small (in relation to the size of the television screen) cross or circle positioned on the television screen to the left of the weapon. The reticule represents where the weapon is pointed. The player can manipulate the location of the reticule (in the game environment) with the handheld game controller, giving the player the illusion that he/she is aiming the weapon. Generally, when the reticule overlaps an enemy (in the game environment), the reticule will change color, indicating to the player that his/her weapon is pointed directly at an enemy. The game controller is typically equipped with a trigger, giving the player the illusion that he/she can aim the weapon, and when the reticule changes color, the player can pull the trigger, theoretically shooting the target, and earn points in the game. The size of the reticule can change based on the kind of weapon the player is wielding. Generally, the size of the reticule will change depending on the precision of the weapon. For example, if the player is wielding a sniper rifle, since it is a high precision weapon, the reticule will be very small (in relation to the size of the television screen). If the player is wielding a low precision weapon, such as a shotgun, the reticule will be quite large (in relation to the size of the television screen). The reticule will be a primary focus of this description.

A common issue that most first person shooter players experience while playing is not being able to acquire the target as fast as the player would like in order to make a “kill” and achieve the highest score possible. It is difficult for most players to quickly move the reticule onto the target and keep the reticule on the target. Especially in combat games, like a first person shooter game, players want to be able to shoot the enemy faster than the enemy can shoot the player, so the ability to acquire the target quickly is essential to success in a first person shooter game. Players will attempt to move the reticule on to the target, and inadvertently, will either move the reticule past the target, will not move the reticule all the way to the target, or will lose sight of the reticule because something in the game environment is the same color as the reticule so that the reticule blends in with the game environment. These kinds of target acquisition problems are known as “target jitters.” Target jitters occur because the reticule is so small (in relation to the entire television screen) that the player has to focus intently on the reticule, making it difficult to find the targets in the game environment. Players find it difficult to acquire targets while having to focus intently on the reticule, because most players do not have adequate peripheral vision to do both at the same time. Target jitters are a common problem, particularly with players who are beginners.

Another issue most players encounter while playing is that, at times, the reticule will disappear from the players' view during game play. As stated earlier, the reticule will at times blend in with the game environment. This will happen when the color of the reticule matches the color of something in the game environment. For example, if the reticule is blue, and the player is targeting something in the sky, since the sky is also blue, the reticule will seem to disappear, and the player will not be able to see where the weapon is pointed. There is another circumstance in which the reticule will disappear. The reticule represents where the weapon is pointed, and when the player is running in the game environment, the weapon is no longer being pointed, and therefore, the reticule is no longer in view. When the player stops running, and is now able to point the weapon, the player may have difficulty focusing back on the reticule when it re-appears.

At this time, there is no prior art that completely addresses target jittering, or the issue of the reticule disappearing in the game environment. One prior system in the industry is called No Scope. No Scope is a clear, plastic decal that a player places directly over the top of the reticule on the television screen. The No Scope, designed to look like scope crosshairs, is an estimated four times the size of the reticule. In most first person shooter games, players are given the ability to “zoom in” when wielding a high precision weapon, such as a sniper rifle. If a player is wielding a sniper rifle, the player can touch a button on the game controller, allowing the player to “zoom in” on a target from a considerable distance. When the player “zooms in”, the game will simulate what a first person view would look like if the player was actually looking through a rifle scope. The player would see a magnified view of the target, but would not be able to see anything else in the game environment.

As stated earlier, when the player is wielding a high precision weapon, the reticule is very small (in relation to the television screen). The smaller the reticule is, the more difficult it is for the player to aim the weapon at targets. A sniper rifle is designed to engage the enemy at a great distance. A sniper rifle is not designed for combat in close quarters. In a first person shooter game, it is difficult for players to shoot a sniper rifle accurately without “zooming in”, because of how small the reticule is with a high precision weapon. No Scope allows the player to shoot more accurately without “zooming in”, because the crosshair-like decal is placed over the reticule, effectively making the small reticule much larger. However, No Scope does not address the issue of target jittering, or the issue of the reticule blending in with the game environment. While No Scope does make the small reticule larger, allowing the player to shoot more accurately without “zooming in”, the player still has to focus on a small portion of the screen, leaving the rest of the game environment to be viewed with the player's peripheral vision, making it difficult for the player to acquire other targets in the game environment. Since No Scope is a decal placed over the reticule, when the reticule disappears, there is still a reference where the reticule would be. However, the shape and design of No Scope are not the same shape and design as the reticule. With No Scope, the player has to constantly adapt between the shape of the reticule (when it disappears) and the shape of the No Scope.

### SUMMARY

This Summary is provided to introduce a selection of concepts in a simplified form that are further described below in the Detailed Description. This Summary, and the foregoing Background, are not intended to identify key aspects or essential aspects of the claimed subject matter. Moreover, this Summary is not intended for use as an aid in determining the scope of the claimed subject matter.

The present technology provides enhanced targeting for first person shooter video games. In various embodiments, vertical and horizontal lines are provided to extend outwardly from the reticule. In some embodiments, the vertical and horizontal lines or bands extend all the way the across the display screen. The width of the lines may vary depending on the size of the television screen. The color of the lines may also vary depending on the player's preference.

The elements of the present technology can be applied to the television screen mechanically or electronically. In some embodiments where this is done electronically, an electronic device is situated between the gaming console or computer, and the television screen or monitor. Various embodiments of the present technology mechanically associate the enhanced reticule with the television screen. In some such embodiments, a piece of clear, thin-film material is cut to the same or similar dimensions as the television screen, with the key graphical design elements of the present invention screen printed on the piece of plastic. Static electricity may be used to hold the film in place in some embodiments. In other embodiments, the film may be held in place by other means, such as a pressure sensitive adhesive, brackets, or other appropriate means.

The present technology allows the player to focus less on the reticule, giving the player a more reliable frame of reference to locate, acquire, target, and defeat the enemy much faster and more surely.

### BRIEF DESCRIPTION OF THE DRAWINGS

Embodiments of the present technology will be described and explained through the use of the accompanying drawings in which:

FIG. 1 depicts a monitor displaying an example of a first person shooter game.

FIG. 2 depicts one embodiment of a targeting system of the present technology.

FIG. 3 depicts the targeting system of FIG. 2 as it overlays the monitor and first person shooter game depicted in FIG. 1.

FIG. 4 depicts a perspective view of the targeting system depicted in FIG. 2 in a spaced-apart relationship with the monitor and first person shooter game depicted in FIG. 1.

FIG. 5 illustrates a set of components within an electronic platform according to one or more embodiments of the present technology.

FIG. 6 is a flowchart illustrating a set of operations for creating a visual overlay in accordance with some embodiments of the present technology.

FIG. 7 is flowchart illustrating a set of operations for electronically generating a customized reticule in accordance with one or more embodiments of the present technology.

FIG. 8 illustrates a reticle within a display that may be generated by some embodiments of the present technology.

FIG. 9 illustrates an adjustable edge gap of a reticle within a display that may be customized by a player, system component, or administrator in accordance with various embodiments of the present technology.

FIG. 10 illustrates an adjustable point of impact gap of a reticle that may be customized by a player, system component, or administrator in accordance with one or more embodiments of the present technology.

FIG. 11 illustrates adjustable portions of a reticle that may be customized by a player, system component, or administrator in accordance with some embodiments of the present technology.

FIG. 12 illustrates various line lengths of a reticle customized by a player, system component, or administrator in accordance with various embodiments of the present technology.

FIG. 13 illustrates various inner line lengths of a reticle customized by a player, system component, or administrator in accordance with one or more embodiments of the present technology.

FIG. 14 illustrates various inner circles with different radii customized by a player, system component, or administrator in accordance with some embodiments of the present technology.

FIG. 15 illustrates inner circles of a reticle having different gauges customized by a player, system component, or administrator in accordance with various embodiments of the present technology.

FIG. 16 illustrates different types of center dots that may be selected or customized by a player, system component, or administrator in accordance with one or more embodiments of the present technology.

FIG. 17 illustrates inner circles of a reticle with different arc angles that may be selected or customized by a player, system component, or administrator in accordance with some embodiments of the present technology.

FIG. 18 illustrates inner circles of a reticle with different arc angle rotations that may be selected or customized by a player, system component, or administrator in accordance with various embodiments of the present technology.

FIG. 19 illustrates various user interface adjustment elements that may be used to customize portions of a reticle in accordance with one or more embodiments of the present technology.

FIG. 20 illustrates an example of a computing platform that may be used by some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

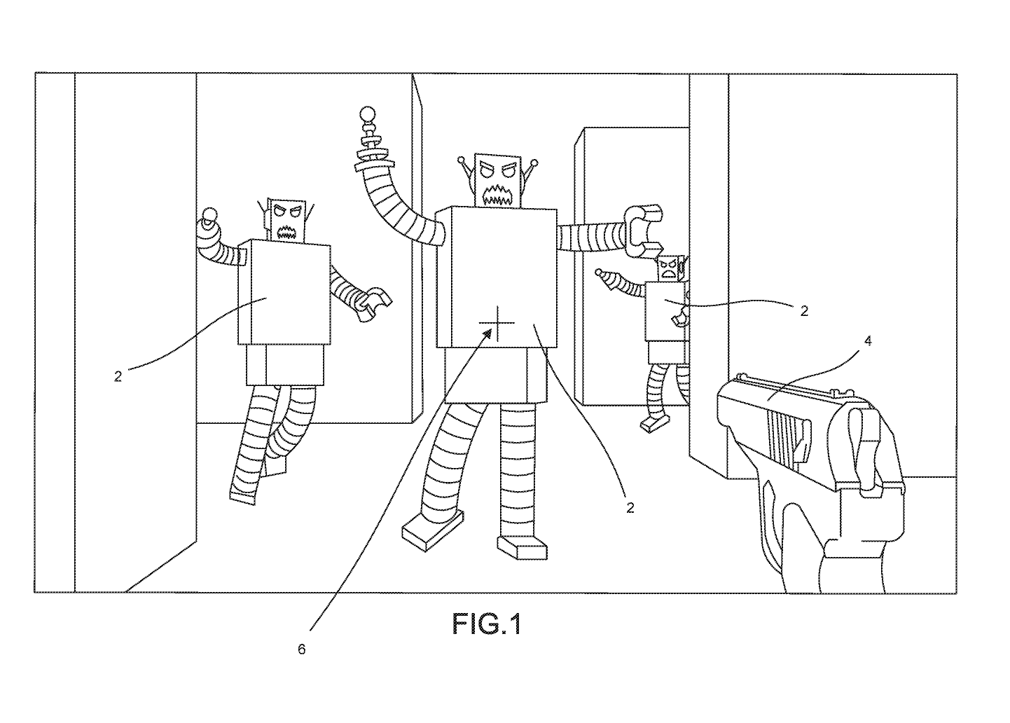

The present technology provides enhanced targeting for first person shooter video games. In certain methods of use, the present technology provides players with a decisive advantage during game play, in both accuracy and speed. With reference to FIG. 1, first person shooter games traditionally give the player only one frame of reference to determine where targets 2 are located and where the weapon 4 is aimed, and that is the reticule 6.

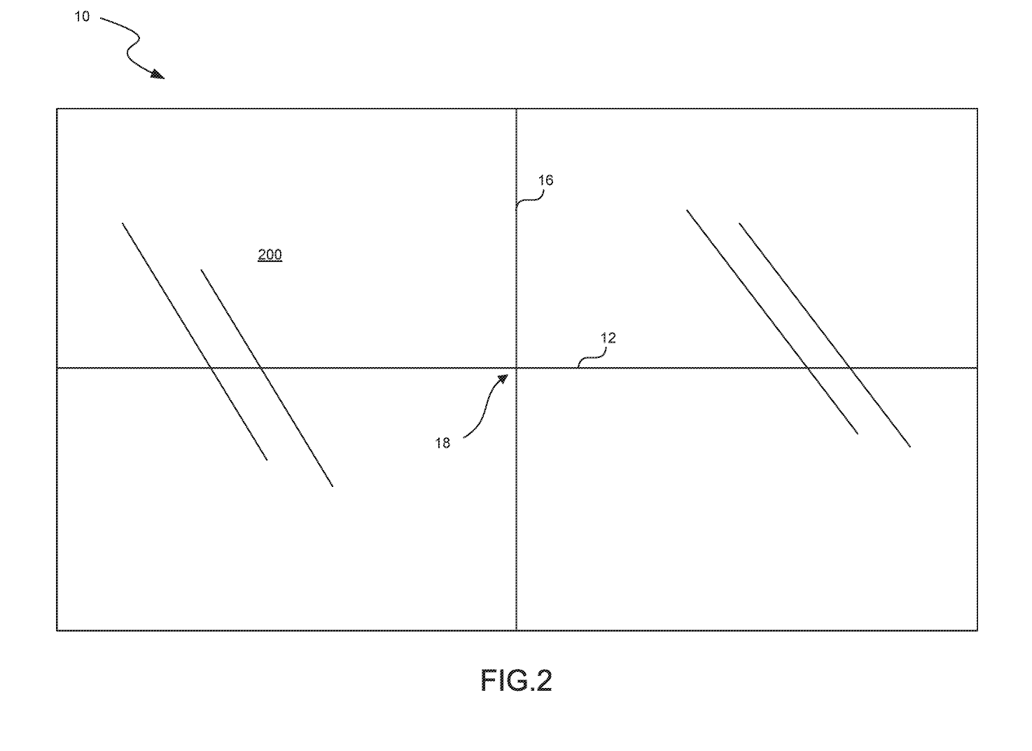

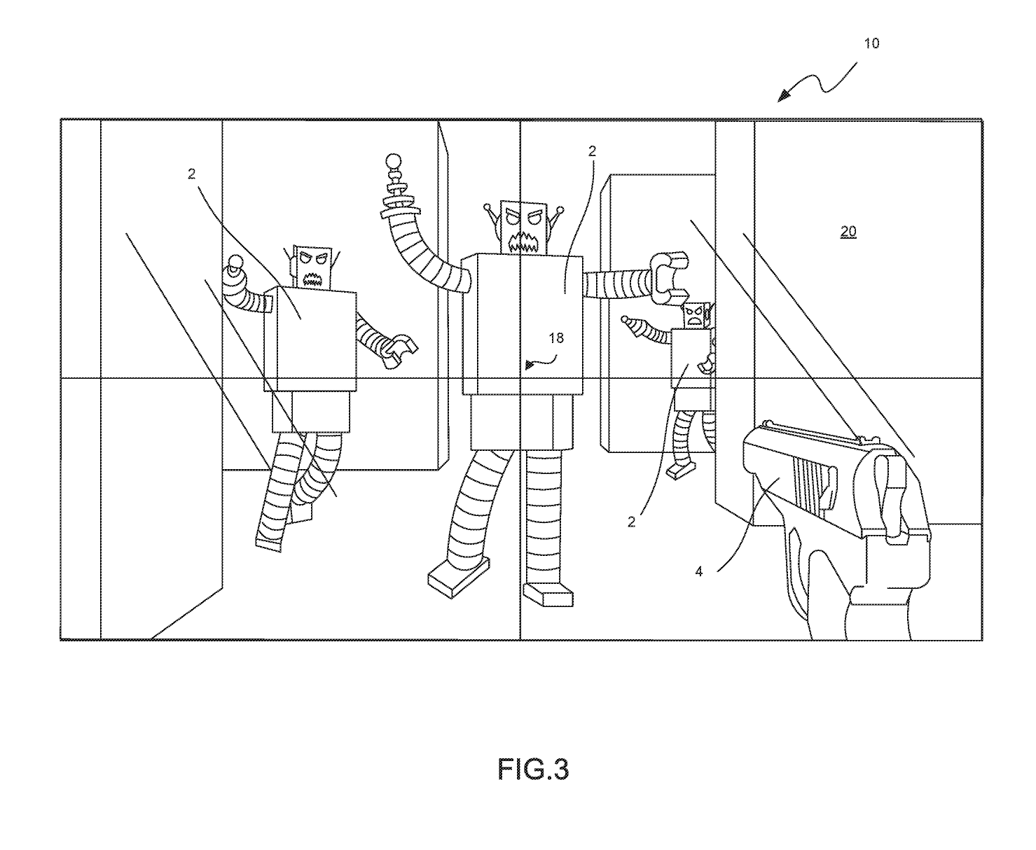

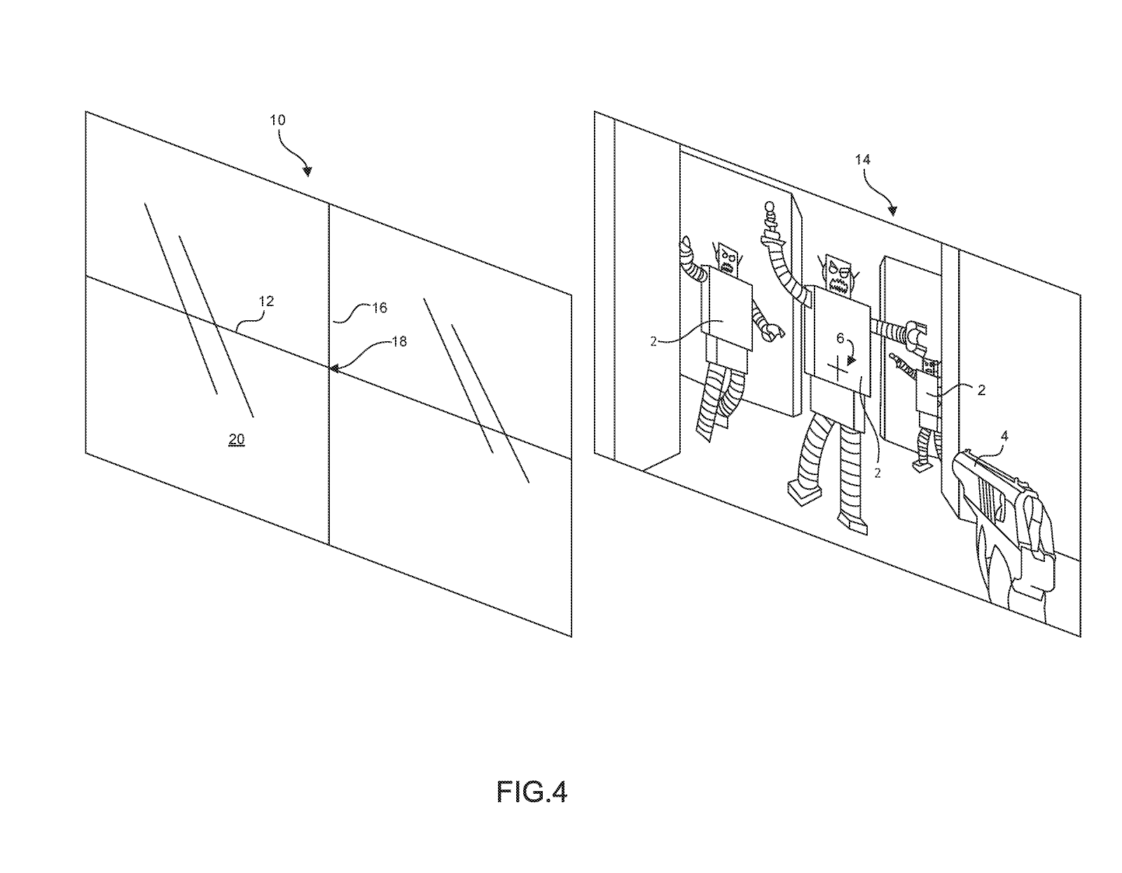

With reference to FIGS. 2-4, various embodiments of the present technology provide the player with a maximum frame of reference by giving the player an enhanced reticule 10 that has a horizontal line 12 running the width of the television screen 14, and a vertical line 16 running the height of the television screen 14, with both lines intersecting at the reticule point 18. Instead of the enhanced reticule 10 being just a small circle, the enhanced reticule 10 now comprises, in some embodiments, a vertical axis and a horizontal axis, with a circle or other graphical focal point at the center (reticule point 18). In some embodiments, the lines and the circle are transparent enough (if made as a “ghost” line or band) or unobtrusive enough (if made as a narrow solid line) as to not obstruct the player's view of the game environment. Having a vertical line 16 and horizontal line 12 or band extending from the reticule point 18 to the edges of the television screen 14 creates a calming effect on the player's eye, allowing the player to not have to focus so intently on the reticule 6, giving the player a greater ability to locate and acquire other targets 2 in the game environment. This calming effect occurs because the player can relate the target 2 to a key additional reference point (the vertical line 16 or horizontal line 12 or band), other than the centrally located reticule 6.

In various embodiments, the reticule point 18, horizontal line 12 and vertical line 16 will not disappear or blend in with the game environment. The horizontal line 12 and vertical line 16, extending from the reticule point 18, provide the player with a maximum frame of reference between the target 2 and where the weapon 4 is pointed. As stated previously, particularly with larger televisions, the target 2 and the reticule 6 can be far enough away from each other that the player actually cannot see them both at the same time. Horizontal line 12 and vertical line 16 extending between the edges of the screen ensuring that, no matter where the target 2 is, the player will always know where the reticule 6 is located. This is due to the fact that the horizontal line 12 and vertical line 16 are never outside of the player's view.

The horizontal line 12 and vertical line 16 also help the player move the reticule 6 onto the target 2 faster because the player does not have to constantly look back and forth between the reticule 6 and the target 2 until finally getting the reticule 6 on the target 2. When the player locates the target 2, anywhere on the screen 14, the player will also be able to see at least one of the horizontal line 12 or vertical line 16. The player can then simply move the nearest line onto the target 2, and move the horizontal line 12 or vertical line 16 until the reticule 6 is on the target 2. This is especially helpful when the target 2 is moving. Players can move one of the horizontal line 12 or vertical line 16 onto the moving target 2, and track the moving target 2 until the reticule 6 is on the target 2. The shortest distance between two points is a straight line, and this technology gives the player greater ability to move the reticule 6 onto the target 2 in a much straighter line, cutting down the distance the reticule 6 has to move, effectively cutting down the time it takes to acquire the target 2. The length and width of the horizontal line 12, vertical line 16, and the circle will vary depending on the size of the television screen. The color of the horizontal line 12, and vertical line 16, and the circle can also vary depending on the player's preference. Because the key elements of the present technology never disappear, players will always have a reticule point 18 on the screen, even when the player is running, or when the reticule 6 provided by the game blends in with the game environment.

The elements of the present technology can be applied to the television screen 14 mechanically or electronically. In some embodiments where this is done electronically, an electronic device is situated between the gaming console or computer, and the television screen 14 or monitor. In one embodiment, the horizontal line 12 and vertical line 16 are lines of light projected onto the video monitor by a projector that is positioned in front of the video monitor. In another embodiment, the lines of light are provided in a color other than white. In yet another embodiment, the projector includes a color selector that may be actuated to change the color of the lines of light between a plurality of predetermined colors. In still another embodiment, the horizontal line 12 and vertical line 16 extend completely across the respective horizontal and vertical axis of a visible display of the video monitor or television screen 14. Other electronic means of applying the present invention to a first person shooter may be used, such as electronically adding the horizontal line 12 and vertical line 16 to the video feed received by the television screen 14.

Various embodiments of the present technology mechanically associate the enhanced reticule with the television screen 14. In some such embodiments, a piece of clear, thin-film material 20 is cut to the same or similar dimensions as the television screen 14, with the key graphical design elements of the present technology screen printed on the piece of thin-film material 20. The thin-film material 20 would be provided, in various embodiments, include various materials (such as various thin-film plastics) and in dimensions that take advantage of static electricity adjacent the television screen 14, which will hold the film in place. In other embodiments, the thin-film material 20 may be held in place by other means, such as a pressure sensitive adhesive, brackets, or other appropriate means.

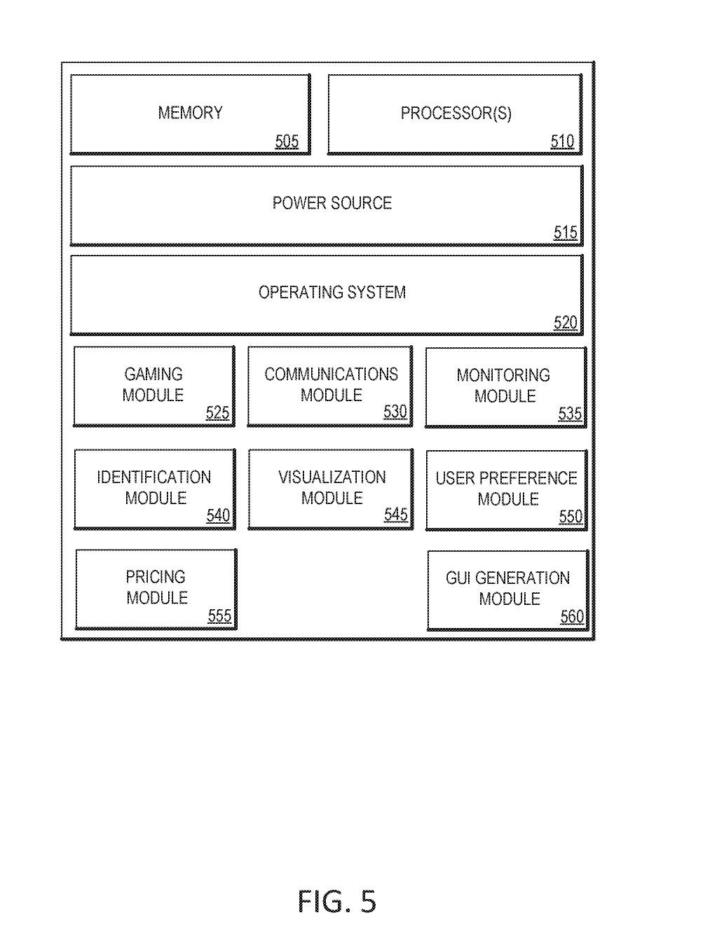

FIG. 5 illustrates a set of components within an electronic platform 500 according to one or more embodiments of the present technology. According to the embodiment shown in FIG. 5, electronic platform 500 can include memory 505, one or more processors 510, power source 515, operating system 520, gaming module 525, communications module 530, monitoring module 535, identification module 540, visualization module 545, user preference module 550, pricing module 555, and graphical user interface (GUI) generation module 560. Each of these modules can be embodied as special-purpose hardware (e.g., one or more application-specific integrated circuits (ASICs), programmable logic devices (PLDs), field-programmable gate arrays (FPGAs), or the like), or as programmable circuitry (e.g., one or more microprocessors, microcontrollers, or the like) appropriately programmed with software and/or firmware, or as a combination of special-purpose hardware and programmable circuitry. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, communications module 530 and monitoring module 535 can be combined into a single module for interacting with a gaming device.

Memory 505 can be any device, mechanism, or populated data structure used for storing information. In accordance with some embodiments of the present technology, memory 505 can encompass, but is not limited to, any type of volatile memory, nonvolatile memory and dynamic memory. For example, memory 505 can be random-access memory, memory storage devices, optical memory devices, magnetic media, floppy disks, magnetic tapes, hard drives, synchronous dynamic random-access memory (SDRAM), Rambus dynamic random-access memory (RDRAM), double data rate random-access memory (DDR RAM), erasable programmable read-only memories (EPROMs), electrically erasable programmable read-only memories (EEPROMs), compact disks, DVDs, and/or the like. In accordance with some embodiments, memory 505 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 505.

Memory 505 may be used to store instructions for running one or more applications or modules on processor(s) 510. For example, memory 505 could be used in one or more embodiments to house all or some of the instructions needed to execute the functionality of operating system 520, gaming module 525, communications module 530, monitoring module 535, identification module 540, visualization module 545, user preference module 550, pricing module 555, and/or GUI generation module 560. Operating system 520 provides a software package that is capable of managing the hardware resources of electronic platform 500. Operating system 520 can also provide common services for software applications running on processor(s) 510.

Gaming module 525 manages the execution of the video game. The video game may allow the user to select different weapons. In some embodiments, the video game may generate a data stream identifying various conditions (e.g., weapon choice, screen colors, number of lives, and the like). This data stream may be transmitted and/or received by communications module 530, which can interpret, translate, or combine the data elements.

Monitoring module 535 can be configured to monitor the data stream (e.g., by using an API such as Overwolf) for a change in gameplay (e.g., weapon choice, color schemes, etc.) that can trigger automatic adjustments in or selection of the reticle being displayed on the screen. Once a trigger is detected, identification module 540 can identify a reticle, or reticle properties, to be displayed. Visualization module 545 communicates with user preference module 550 to identify the user preferences for the reticle elements (e.g., size, spacing, line gauge, arc angles, etc.) before creating a visualization of the reticle.

One possible implementation includes application software built such that it will listen to specific game events and respond in real-time. For example, when a user wants to display a different reticle for each of three weapons in a particular first person shooter game, and the application software is to automatically change reticles when the user changes weapons in-game. A variable (e.g., “currentWeapon”) can hold the value of the current active weapon, and it can have one of three values: “rifle,” “pistol,” “shotgun.” The user may have selected three different reticles, either by selecting pre-defined reticle configurations that ship with the application or by the user-accessible reticle-building controls: Ret01 (for rifle); Ret02 (for pistol); Ret03 (for shotgun). The application holds the current reticle value in a variable (e.g., currentReticle”).

The application can be trained to monitor or listen to “currentWeapon” for this game. The application may also have a user-defined table to select the correct reticle for the current weapon:
if currentWeapon equals “rifle” then
   set currentReticle equal to “Ret01”;
else if currentWeapon equals “pistol” then
   set currentReticle equal to “Ret02”;
else
   set currentReticle equal to “Ret03”

This process has the effect that, when the user changes weapons in-game (e.g., changing the active weapon from pistol to shotgun), the application will cease displaying one reticle design and begin displaying another (Ret02 and begin displaying Ret03). This same process could be implemented to respond to a wide variety of game events such as changes in maps, timed events, number of player deaths, number of enemy deaths, ammunition levels, etc.

In some embodiments, the system can accept the rendered screen (in part or in whole) as input to trigger reticle changes/alterations. For example, when a user wants to display different reticle parameters for lighter or darker game environments. As a result, for lighter environments, the reticle features (lines, circles, etc.) could be thinned (i.e., small gauge); for darker environments, the reticle features could be thick (i.e., large gauge). A variable (e.g., “screenValue”) can store the result of taking the average brightness value (from 0.0 to 1.0, 0.0 being totally black for all pixels and 1.0 being totally white for all pixels) of the input pixels. Another variable (e.g., “lineGauge”) may hold the current width, in pixels, of the thickness of lines that comprise the displayed reticle. For example, if the user has defined a threshold of 0.5, a screenValue values less than or equal to 0.5 sets lineGauge to 8 pixels and a screenValue values greater than 0.5 sets lineGauge to 4 pixels.

One possible implementation includes the reticle-generating code as an integral part of a given game's software. As a result, the game software may actively pass variable values directly to the reticle-generating code. For example, a user may want to game and reticle-generating code to display different center dot shapes to correspond to different enemy types. As an enemy's on-screen rendered image enters within a given radius, measured in pixels, of the point of impact, the center dot shape is changed to correspond to this enemy type. A variable (e.g., “enemyRange”) can store the current proximity, in pixels, of the center of the enemy's on-screen rendered image to the point of impact. Another variable (“enemyType”) can store the value of a given enemy's type, and can hold one of three values, for example, “goblin,” “troll,” and “ogre.” A reticle-generating code variable (e.g., “currentCenterDot”) can store the value of the currently displayed center dot shape, and it can hold one of three values, for example, “dot01” (for a circle), “dot02” (for a square), and “dot03” (for a diamond). A reticle-generating code variable (e.g., “centerDotThreshold”) can store a predetermined (possibly user defined) distance, in pixels, from the point of impact.

The game software passes the values of “enemyRange” and “enemyType” to the reticle-generating code. The reticle code compares the value of “enemyRange” to “centerDotThreshold.” If “enemyRange” is less than or equal to “centerDotThreshold,” the reticle code refers to a predefined or user-defined table of values to select and display the center dot shape that corresponds to the “enemyType”. For example, this code may be viewed as:
if enemyRange is less than or equal to centerDotThreshold then
   if enemyType equals “goblin” then
      set currentCenterDot to “dot01”;
   else if enemyType equals “troll” then
      set currentCenterDot to “dot02”;
   else
      set currentCenterDot to “dot03”;

Pricing module 555 may require a user to pay for integration of the electronic reticle. GUI generation module 560 can generate one or more GUI screens that allow for interaction with a user. In at least one embodiment, GUI generation module 560 can generate a graphical user interface allowing a user to set preferences, review reports, author customization profiles, set device constraints, and/or otherwise receive or convey information about reticle customization to the user.

For example, GUI generation module 560 may allow a user to set shaping parameters such as, but not limited to, line segments. The customization of the line segments may allow the user to select the line gauge (thickness of line segments). In some embodiments, there may be four parameters, each is user (or system) adjustable. All four line segments can be controlled collectively or independently. For example, outer line gauge representing the thickness of the portion of a line toward the edge of screen (this end is typically thicker) may be adjusted. The inner line gauge representing the thickness of portion of line toward the center of screen (this end is typically thinner) may be adjusted. The gauge taper length representing the length of transition between outer and inner portions of a line segment (the transition tapers from a thicker portion of a line down to a thinner portion of the line) may be adjusted. The gauge taper position representing the placement along the length of a line segment where transition occurs may be adjusted.

In some embodiments, the line length may have two parameters per direction (horizontal and vertical), each is user adjustable; lengths in each direction can be controlled collectively or independently. This may be represented as a percentage or of the screen or window in some embodiments. In other cases, the lengths may range from essentially within the center of the window or display to the edge itself (e.g., 20%-100% coverage). Embodiments of the present technology present horizontal and vertical sight lines having lengths that extend substantially across (greater than 50% across) a height and/or width of the window or display. In particular embodiments the lengths may range a distance of least 20%-30% from the center of the window or display to the edge. In other embodiments the lengths may range a distance of 30%-40% from the center of the window or display to the edge. In further embodiments the lengths may range a distance of 40%-50% from the center of the window or display to the edge. Still other embodiments provide lengths that range a distance of 50%-60% from the center of the window or display to the edge. In another embodiment the lengths may range a distance of 60%-70% from the center of the window or display to the edge. Other embodiments provide the lengths to range a distance of 70%-80% from the center of the window or display to the edge. In further embodiments the lengths range a distance of 80%-90% from the center of the window or display to the edge. In other embodiments the lengths range a distance of 90%-100% from the center of the window or display to the edge. For example, the edge gap representing the length of gap between the edge of the screen and the distal end of a line segment may be adjusted. The point of impact gap representing the length of the gap between the center of the reticle (Point Of Impact) and proximal end of line segment may be adjusted. The point of impact representing the center of reticle, where line segments do, or are implied to, intersect may be adjusted. The location of the point of impact may have two parameters, each user (or system) adjustable. These may include the horizontal location (will tend to be placed in center of game screen as most first- or third-person shooters place the in-game Point Of Impact in the center of the game screen horizontally). The vertical location (which will likely vary to accommodate different Points Of Impact from game to game and from game mode to game mode in the same game) may be set.

The center circle may be a hollow circle centered on Point Of Impact. Four parameters may be used, each user (or system) adjustable. The circle gauge representing the thickness of the line rendering the perimeter of the circle may be adjusted. The radius may be adjusted to set the size of the circle on the screen. The arc angle, representing how many degrees of the circle are rendered, from 0° to 360°, may be adjusted. And the arc angle rotation, that is, the position, in degrees, of the mid-point along the arc length, may be adjusted.

The center dot, if any, representing the solid shape centered on Point Of Impact may be set using three or more parameters that are each user (or system) adjustable. For example, the shape may be selected from a predefined set of shapes (e.g., circle, square, diamond, etc.) The radius may be adjusted to set the size of the shape on the screen. A user image may be selected from an image of the user's library (example, from the user's hard drive or USB flash storage device) to be used as the center dot object in place of a predefined shape.

Visibility may also be adjusted in some embodiments. In some embodiments, three different kinds of controls may be used to affect visibility. For example, a variable to set the opacity of reticle elements (0% to 100% opacity) may be applied to reticle elements individually or collectively. And a gradient may be used to gradually alter the opacity radially from Point Of Impact; These two parameters may be applied individually or collectively. A gradient amount representing the percent reduction in opacity (0% to 100%) from the edge of the gradient radius to the center may be used. A gradient radius determining the on-screen radius over which the opacity gradient occurs may also be used. A binary “on/off” toggle displays or hides reticle elements individually. In addition, variable opacity value may be persistent through toggle cycles (e.g., if variable opacity is set to 75% for the center the circle, it will remain at 75% whether the binary value is turned on or off).

The color of reticle elements may be determined and applied individually or collectively. Color selection may use three different methods, to offer user control over reticle color. For example, a color picker with a gradient field from which a user can pick color by moving the cursor/pointer over the field and selecting a color may be used. Other available methods include RGB/HSB: sliders/spinners/numerical entry for selecting color; red/green/blue; or hue/saturation/brightness methods may be available. A color swatch may allow a user to select colors from an array of predefined swatches. Color gradient controls may gradually blend two colors radially, centered on the point of impact. A gradient radius may be used to determine when an on-screen radius over which color gradient occurs.

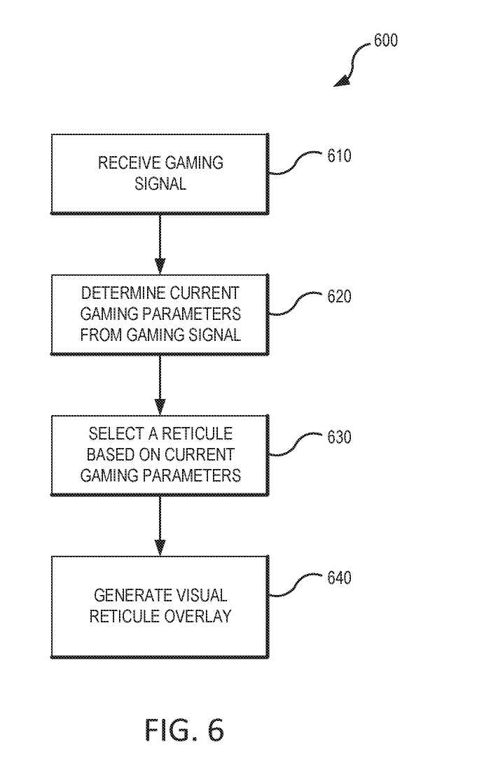

FIG. 6 is a flowchart illustrating a set of operations 600 for creating a visual overlay in accordance with some embodiments of the present technology. The operations illustrated in FIG. 6 can be performed by an electronic device and/or one or more components (e.g., processor(s) 510), engines, and/or modules (e.g., visualization module 545) associated with the electronic device. As illustrated in FIG. 6, a gaming signal is received during receiving operation 610. Determination operation 620 determines the current gaming parameters (or variables) from the gaming signal. Selection operation 630, selects a reticule based on the current gaming parameters. Then, generation operation 640 generates a visual reticule overlay that may be displayed on the same screen as the game play.

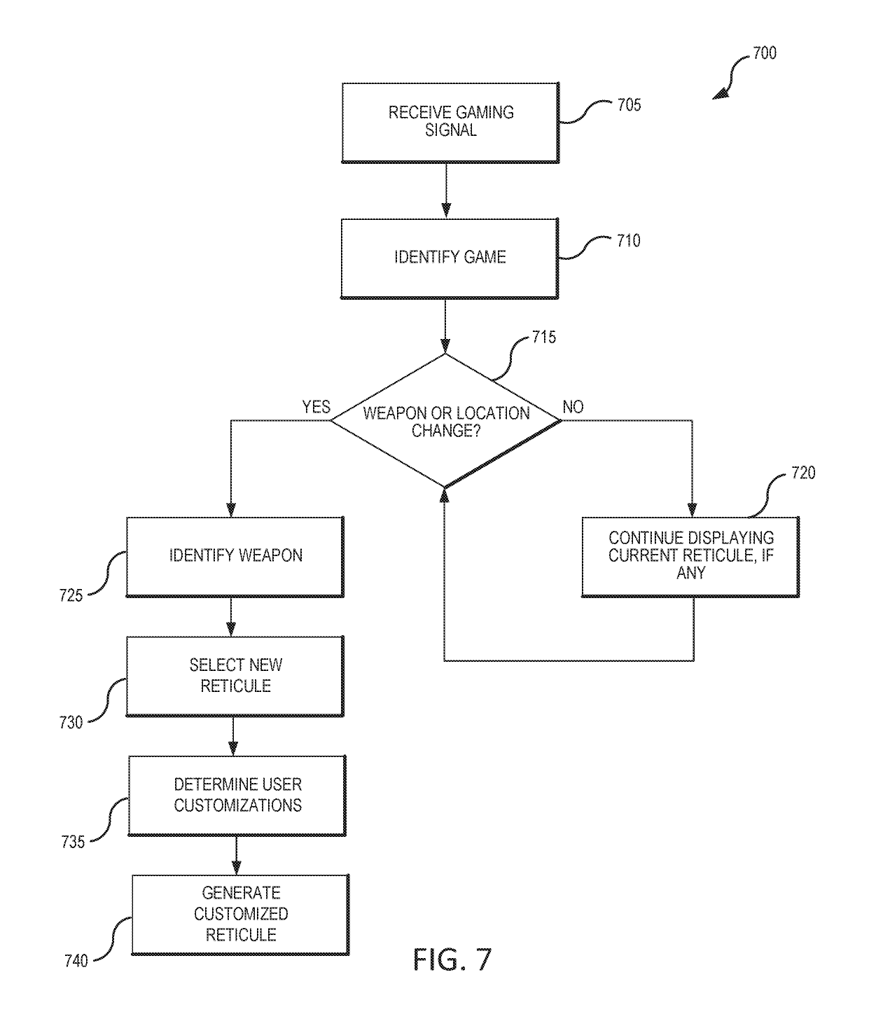

FIG. 7 is flowchart illustrating a set of operations 700 for electronically generating a customized reticule in accordance with one or more embodiments of the present technology. The operations illustrated in FIG. 7 can be performed by an electronic device (e.g., a mobile device, computer, tablet, etc.) or one or more components (e.g., processor(s) 510), engines, and/or modules. As illustrated in FIG. 7, receiving operation 705 receives a gaming signal. Depending on the system configuration, this signal may be received from an external source (e.g., a separate gaming console, via the Internet, etc.) or exist within a single application.

During identification operation 710, the game and/or gameplay is identified from the gaming signal. Using this information, determination operation 715 may determine whether a weapon, location or other parameter change has occurred. If determination operation 715 determine no change has occurred, then determination operation 715 branches to display operation 720 where the current reticle, if any, is continued to be displayed. If determination operation 715 determine a change has occurred, then determination operation 715 branches to identification operation 725 where a current weapon or gameplay state is identified. Selection operation 730 selects a new reticule based on the current weapon or gameplay. Customization operation 735 determines the user customization to the reticle based on the weapon or gameplay and generation operation 740 generates the customized reticle.

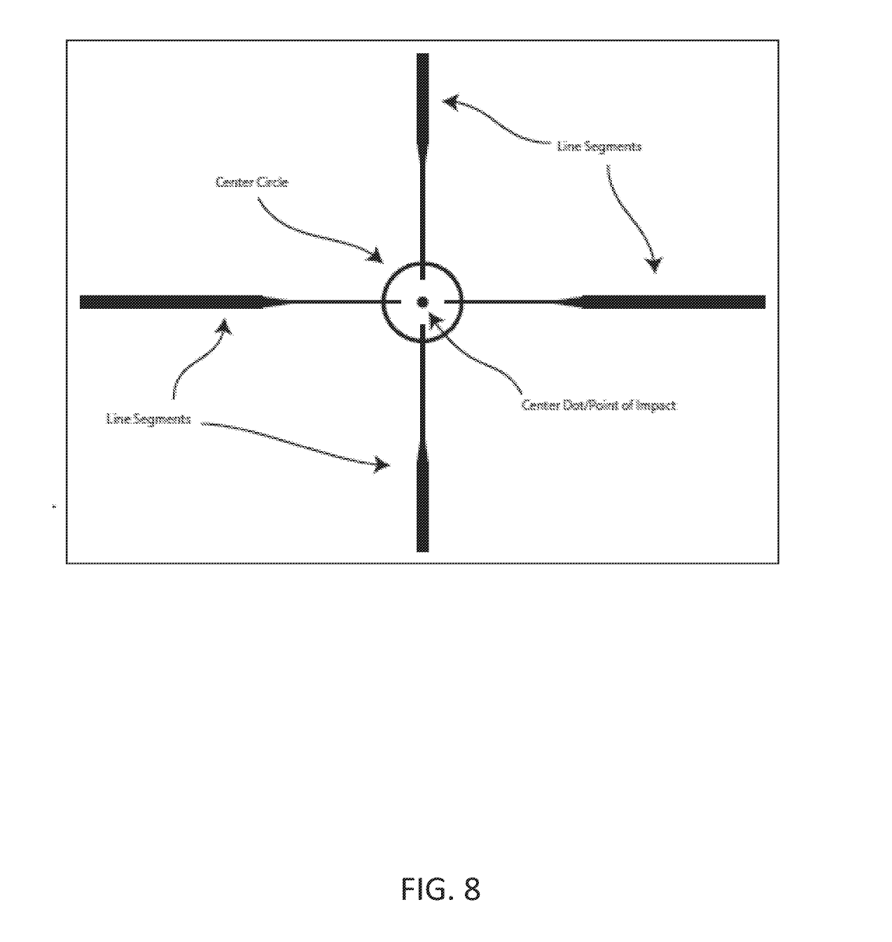

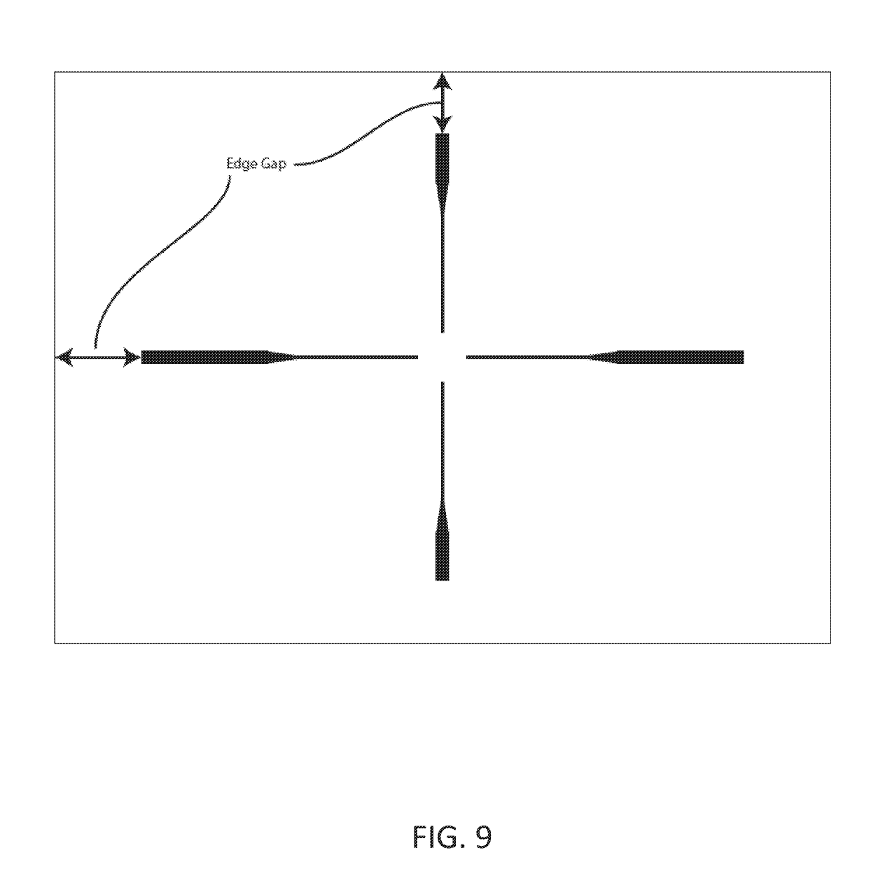

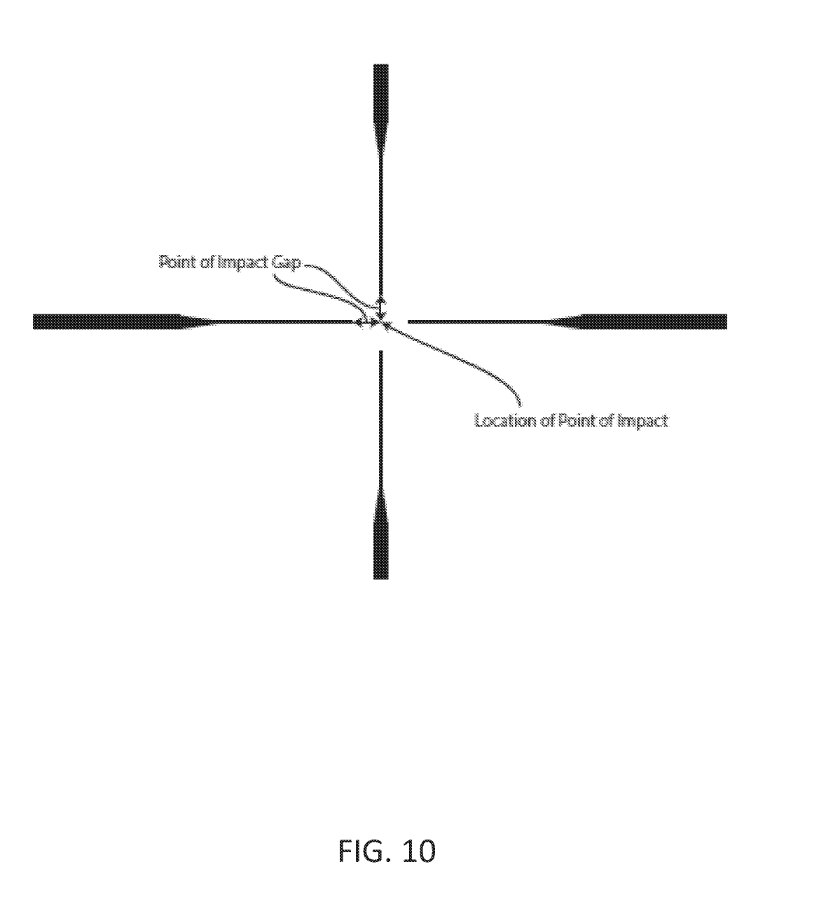

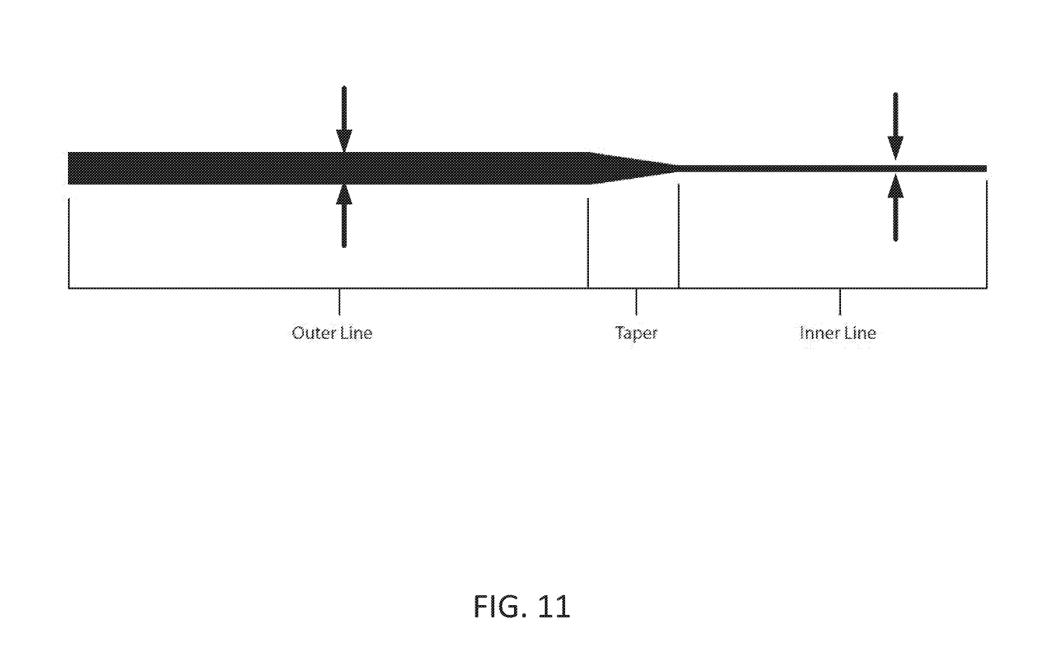

FIG. 8 illustrates a reticle within a display that may be generated by some embodiments of the present technology. While a single display window is shown in FIG. 8, some embodiments provide for the display to be divided into multiple windows (e.g., for multiple players). Each of the multiple windows may or may not include reticle each of which can be individually customized (e.g., based on a player ID). FIG. 9 illustrates an adjustable edge gap of a reticle within a display that may be customized by a player, system component, or administrator in accordance with various embodiments of the present technology. The adjustable edge gap may be set so that gap is small or large (e.g., more than 50% of the size of the window). FIG. 10 illustrates an adjustable point of impact gap of a reticle that may be customized by a player, system component, or administrator in accordance with one or more embodiments of the present technology. FIG. 11 illustrates adjustable portions of a reticle that may be customized by a player, system component, or administrator in accordance with some embodiments of the present technology.

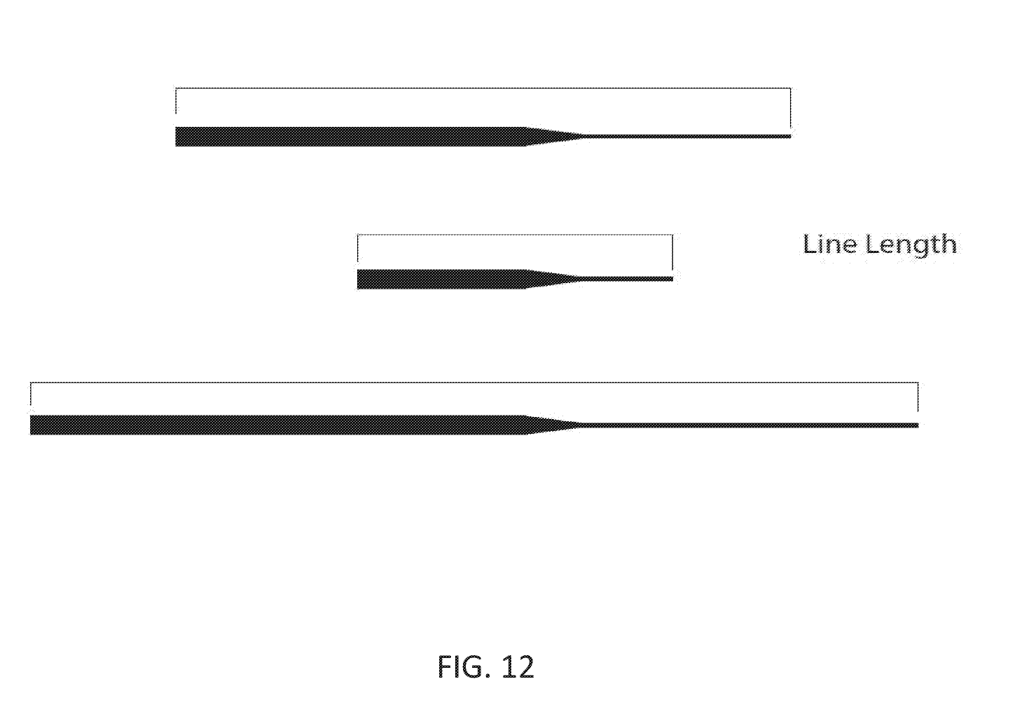

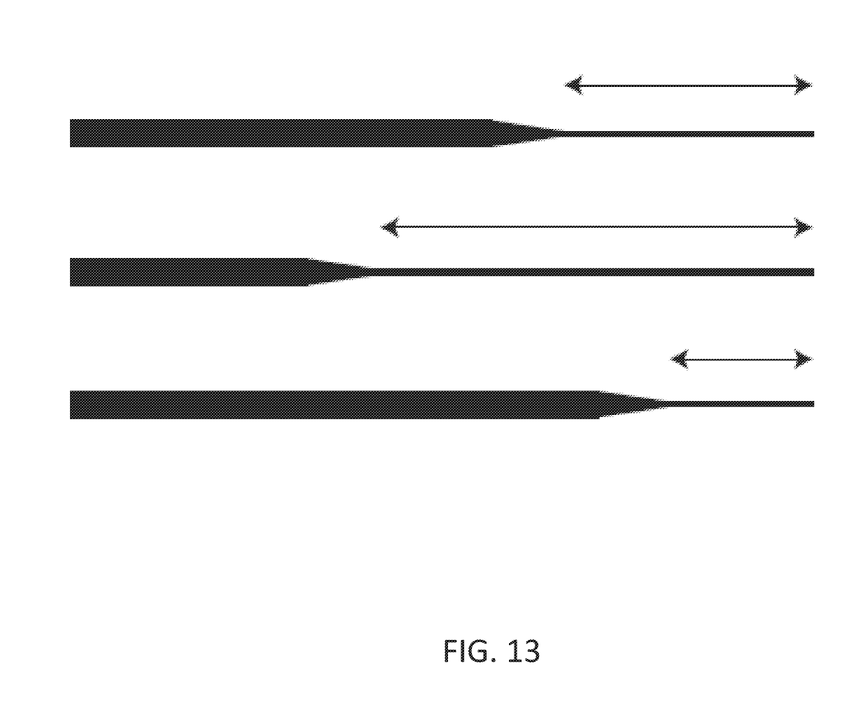

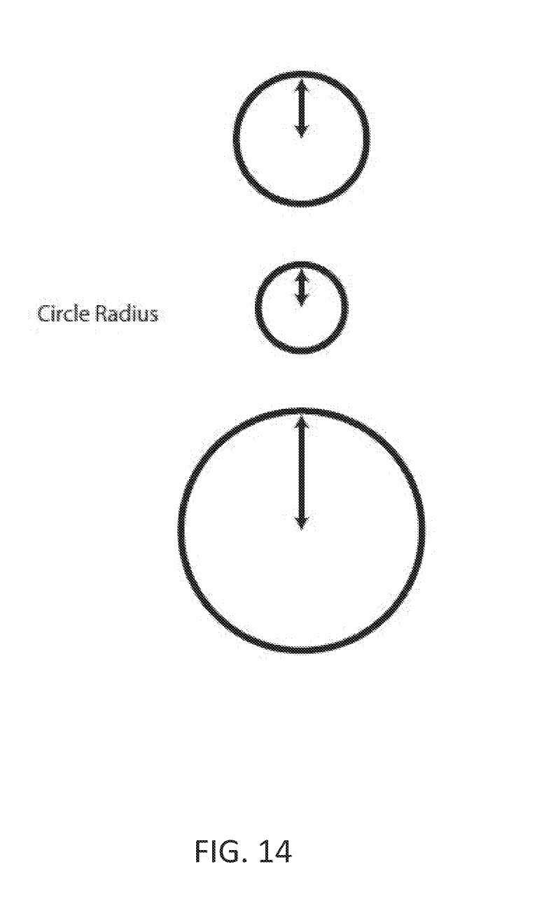

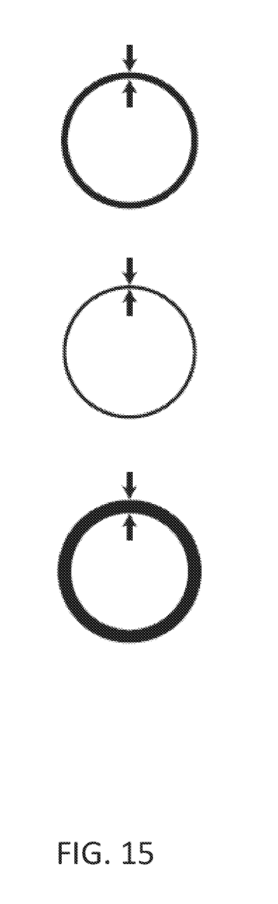

FIG. 12 illustrates various line lengths of a reticle customized by a player, system component, or administrator in accordance with various embodiments of the present technology. FIG. 13 illustrates various inner line lengths of a reticle customized by a player, system component, or administrator in accordance with one or more embodiments of the present technology. FIG. 14 illustrates various inner circles with different radii customized by a player, system component, or administrator in accordance with some embodiments of the present technology. FIG. 15 illustrates inner circles of a reticle having different gauges customizable by a player, system component, or administrator in accordance with various embodiments of the present technology.

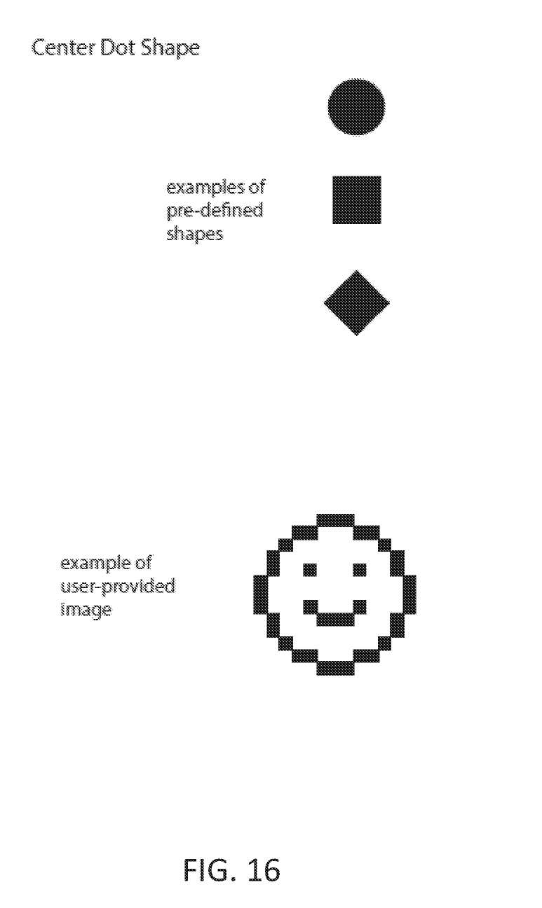

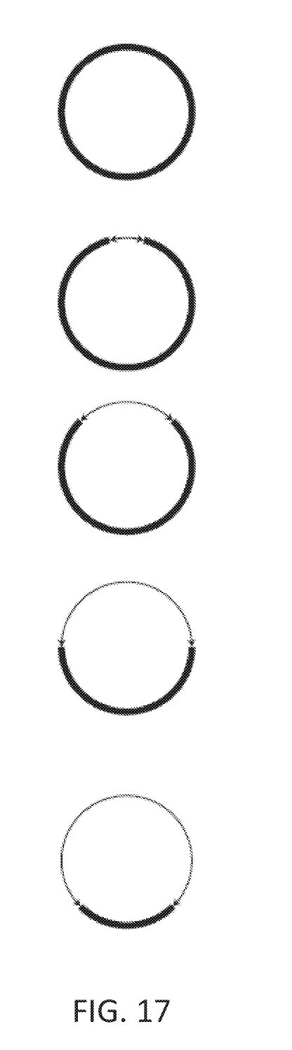

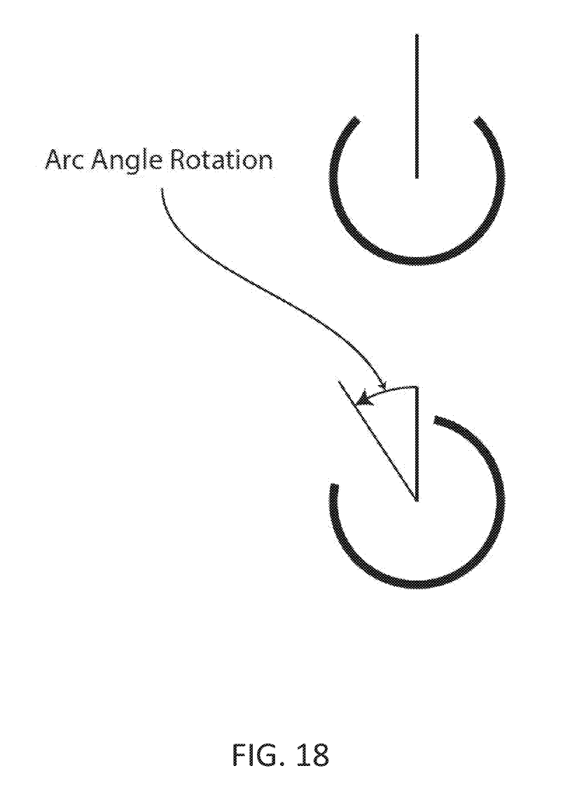

FIG. 16 illustrates different types of center dots that may be selected or customized by a player, system component, or administrator in accordance with one or more embodiments of the present technology. FIG. 17 illustrates inner circles of a reticle with different arc angles that may be selected or customized by a player, system component, or administrator in accordance with some embodiments of the present technology. FIG. 18 illustrates inner circles of a reticle with different arc angle rotations that may be selected or customized by a player, system component, or administrator in accordance with various embodiments of the present technology.

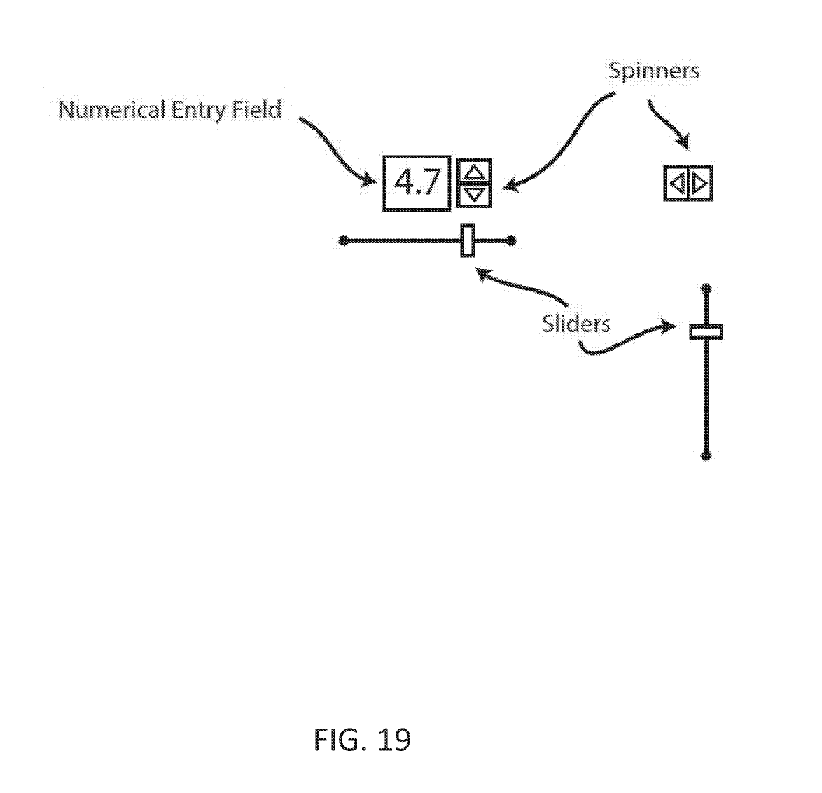

FIG. 19 illustrates various user interface adjustment elements that may be used to customize portions of a reticle in accordance with one or more embodiments of the present technology.

In accordance with various embodiments, the system may be implemented as a PC/Console with application software that resides on and is operated from the same hardware that the game is being run from. A Smart TV/Smart Monitor variant may have application software that resides on it and is operated from the monitor that the game is being viewed on. Other embodiments may use a hardware pass-through box having application software that resides on and is operated from a dedicated hardware device. As a result, the signal from the gaming platform is input to this device, the reticle application running on this dedicated hardware adds the reticle to the video signal, and the signal is sent to the monitor.

Game-independent embodiments allow the application to operate with no input directly from game software, so the game operates with no input from reticle application software; this setup is unavoidable in the Smart TV/Smart Monitor and hardware pass-through vectors. Game-dependent embodiments provide game interfacing with a reticle application as a separate piece of software running independently from game software, but they may take input from game software to automatically update the reticle to accommodate reticle-altering mode changes in-game (e.g., change of weapon, change of venue, change of screen value/brightness, etc.). Game integration embodiments with reticle functionality integrated into game software, either as an integral part of the software or as an add-on or plug-in may be used. In some cases, the reticle functionality may be available only via purchase.

### Exemplary Computer System Overview

Aspects and implementations of the gaming and reticle generation system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, gaming console, or other computing device) programmed with the instructions, to perform the steps or operations. For example, the steps or operations may be performed by a combination of hardware, software, and/or firmware.

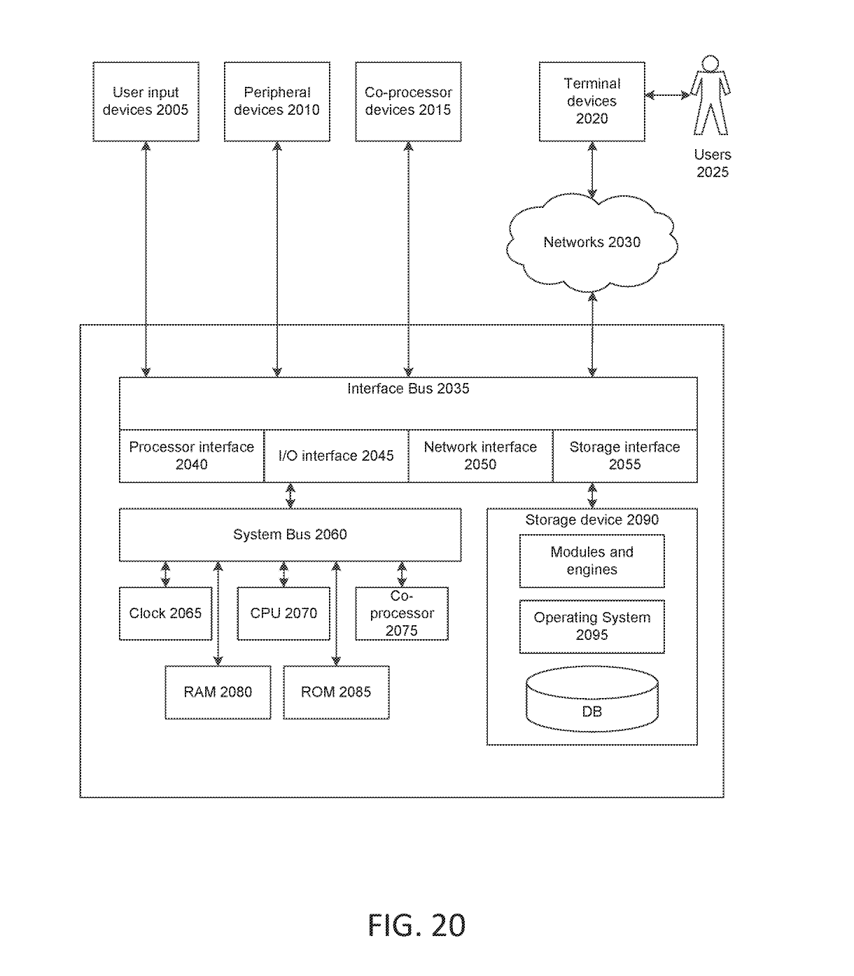

FIG. 20 is a block diagram illustrating an example machine representing the computer systemization of the gaming and reticle generation system. The system controller 2000 may be in communication with entities including one or more users 2025, client/terminal devices 2020, user input devices 2005, peripheral devices 2010, optional co-processor device(s) 2015 (e.g., cryptographic processor devices), and networks 2030. Users may engage with the gaming system via terminal devices 2020 over networks 2030.

Computers may employ a central processing unit (CPU) or processor to process information. Processors may include programmable general-purpose or special-purpose microprocessors, programmable controllers, application-specific integrated circuits (ASICs), programmable logic devices (PLDs), embedded components, a combination of such devices, and the like. Processors execute program components in response to user- and/or system-generated requests. One or more of these components may be implemented in software, hardware, or both hardware and software. Processors pass instructions (e.g., operational and data instructions) to enable various operations.

The controller 2000 may include clock 2065, CPU 2070, memory such as read only memory (ROM) 2085 and random access memory (RAM) 2080 and co-processor 2075 among others. These controller components may be connected to a system bus 2060, and through the system bus 2060 to an interface bus 2035. Further, user input devices 2005, peripheral devices 2010, co-processor devices 2015, and the like, may be connected through the interface bus 2035 to the system bus 2060. The interface bus 2035 may be connected to a number of interface adapters such as processor interface 2040, input output interfaces (I/O) 2045, network interfaces 2050, storage interfaces 2055, and the like.

Processor interface 2040 may facilitate communication between co-processor devices 2015 and co-processor 2075. In one implementation, processor interface 2040 may expedite encryption and decryption of requests or data. Input output interfaces (I/O) 2045 facilitate communication between user input devices 2005, peripheral devices 2010, co-processor devices 2015, and/or the like and components of the controller 2000 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 2050 may be in communication with the network 2030. Through the network 2030, the controller 2000 may be accessible to remote terminal devices 2020. Network interfaces 2050 may use various wired and wireless connection protocols such as, direct connect, Ethernet, wireless connection such as IEEE 802.11a-x, and the like.

Examples of network 2030 include the Internet, Local Area Network (LAN), Metropolitan Area Network (MAN), a Wide Area Network (WAN), wireless network (e.g., using Wireless Application Protocol WAP), a secured custom connection, and the like. The network interfaces 2050 can include a firewall which can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed by or included in the functions of the firewall can be, for example, but are not limited to, intrusion-prevention, intrusion detection, next-generation firewall, personal firewall, etc., without deviating from the novel art of this disclosure.

Storage interfaces 2055 may be in communication with a number of storage devices such as, storage devices 2090, removable disc devices, and the like. The storage interfaces 2055 may use various connection protocols such as Serial Advanced Technology Attachment (SATA), IEEE 1394, Ethernet, Universal Serial Bus (USB), and the like.

User input devices 2005 and peripheral devices 2010 may be connected to I/O interface 2045 and potentially other interfaces, buses and/or components. User input devices 2005 may include card readers, finger print readers, joysticks, keyboards, microphones, mouse, remote controls, retina readers, touch screens, sensors, and/or the like. Peripheral devices 2010 may include antenna, audio devices (e.g., microphone, speakers, etc.), cameras, external processors, communication devices, radio frequency identifiers (RFIDs), scanners, printers, storage devices, transceivers, and/or the like. Co-processor devices 2015 may be connected to the controller 2000 through interface bus 2035, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The controller 2000 may employ various forms of memory including on-chip CPU memory (e.g., registers), RAM 2080, ROM 2085, and storage devices 2090. Storage devices 2090 may employ any number of tangible, non-transitory storage devices or systems such as fixed or removable magnetic disk drive, an optical drive, solid state memory devices and other processor-readable storage media. Computer-executable instructions stored in the memory may include the gaming and reticle generation system having one or more program modules such as routines, programs, objects, components, data structures, and so on that perform particular tasks or implement particular abstract data types. For example, the memory may contain operating system (OS) component 2095, modules and other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, stack, structured text file (e.g., XML), table, and/or the like. Such data-structures may be stored in memory and/or in structured files.

The controller 2000 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 2000 may be distributed electronically over the Internet or over other networks (including wireless networks). Those skilled in the relevant art(s) will recognize that portions of the gaming and reticle generation system may reside on a server computer, while corresponding portions reside on a client computer. Data structures and transmission of data particular to aspects of the controller 2000 are also encompassed within the scope of the disclosure.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms.

Accordingly, the actual scope of the technology encompasses not only the disclosed examples, but also all equivalent ways of practicing or implementing the technology under the claims. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A system comprising:
a display;
a processor;
an electronic gaming module running on the processor to display a first-person shooter game in a window on the display; and
a targeting module running on the processor to:
generate a targeting reticule comprising: (i) a horizontal sight line having a length extending substantially across a width of the window to a left edge and a right edge of the window; and (ii) a vertical sight line having a length extending across a height of the window positioned closely adjacent to a top edge and a bottom edge of the window; and
wherein the horizontal sight line and vertical sight line of the targeting reticule are positioned with respect to one another and the window such that the horizontal sight line and vertical sight line intersect at a targeting point; the targeting point positioned at a center point of the window; whereby the center point may be moved from a position away from a target displayed on the window to a position at least partially over the target by manipulating a controller of the electronic gaming system so that the target is moved along at least one of the horizontal sight line and the vertical sight line until the target is at least partially beneath the center point.

2. The system of claim 1, wherein the horizontal sight line and vertical sight line extend completely across the respective horizontal and vertical axis of a visible window of the display.

3. The system of claim 1, further comprising an identification module to identify one or more gameplay variables.

4. The system of claim 3, wherein the one or more gameplay variables include active weapon type.

5. The system of claim 3, further comprising a user preference module to retrieve a reticle customization based on the one or more gameplay variables.

6. The system of claim 5, wherein the reticle customization includes a center circle radius, an edge gap distance, an outer line gauge, a taper length, and an inner line gauge.

7. The system of claim 1, wherein the targeting reticule includes at least a partial center circle.

8. The system of claim 1, wherein the electronic gaming module running on the processor displays the first-person shooter game multiple windows on the display and targeting module generates the targeting reticule in each of the multiple windows.

9. A non-transitory computer readable medium having instructions stored thereon that when executed by one or more processors cause a machine to:
receive a gameplay signal having one or more gaming parameters representing features of current gameplay action;
identify customization parameters based on the one or more gaming parameters; and
generate a targeting reticule based on the customization parameters, the targeting reticle comprising: (i) a horizontal sight line having a length extending across at least a portion of a window and positioned within a first edge distance of a left edge and a right edge of the window; and (ii) a vertical sight line having a length extending across at least a portion of a height of the window positioned within a second edge distance to a top edge and a bottom edge of the window; and
wherein the horizontal sight line and vertical sight line of the targeting reticule are positioned with respect to one another and the window such that the horizontal sight line and vertical sight line intersect at a targeting point positioned at a center point of the window.

10. The non-transitory computer readable medium of claim 9, wherein the horizontal sight line and vertical sight line extend completely across the respective horizontal and vertical axis of the window.

11. The non-transitory computer readable medium of claim 9, wherein the instructions when executed by the one or more processors further cause the machine to identify one or more gameplay variables.

12. The non-transitory computer readable medium of claim 11, wherein the one or more gameplay variables include active weapon type.

13. The non-transitory computer readable medium of claim 11, wherein the instructions when executed by the one or more processors further cause the machine to retrieve a reticle customization based on the one or more gameplay variables.

14. The non-transitory computer readable medium of claim 13, wherein the reticle customization includes a center circle radius, an edge gap distance, an outer line gauge, a taper length, and an inner line gauge.

15. The non-transitory computer readable medium of claim 9, wherein the targeting reticule includes at least a partial center circle.

16. A targeting module comprising:
a communications module configured to receive a stream of gameplay data from a gaming module;
a processor executing instructions to:
generate a targeting reticule to be overlaid on a gaming screen generated by the gaming module, the targeting reticule comprising: (i) a horizontal sight line having a length extending across a substantial portion of the gaming screen; and (ii) a vertical sight line having a length extending across a substantial portion of a height of the gaming screen; and
wherein the horizontal sight line and vertical sight line of the targeting reticule are positioned with respect to one another and the gaming screen such that the horizontal sight line and vertical sight line intersect at a targeting point positioned at a desired point of the gaming screen.

17. The targeting module of claim 16, wherein the targeting module and the gaming module are integrated into a single system.

18. The targeting module of claim 16, further comprising an identification module to identify one or more variables from the gameplay data and automatically adjust properties of the targeting reticule.

19. The targeting module of claim 16, wherein the properties of the targeting reticule automatically adjusted include a center circle radius, an edge gap distance, an outer line gauge, a taper length, and an inner line gauge.

20. The targeting module of claim 16, wherein the electronic gaming module is generating multiple gaming screens and the instructions when executed by the processor generate targeting reticules in each of the multiple gaming screens.
